(19) United States
(12) Patent Application Publication
(10) Pub. No.: US 2016/0274269 A1
(43) Pub. Date: Sep. 22, 2016

(54) Geocellular Modeling

(71) Applicant: LANDMARK GRAPHICS CORPORATION, Houston, TX (US)

(72) Inventors: Jeffrey M Yarus, Houston, TX (US); Genbao Shi, Sugar Land, TX (US); Veronica Liceras, Katy, TX (US)

(21) Appl. No.: 14/768,910

(22) PCT Filed: Dec. 13, 2013
(86) PCT No.: PCT/US13/75084

§ 371 Date: Aug. 19, 2015

Related U.S. Application Data
(60) Provisional application No. 61/909,843, filed on Nov. 27, 2013.

(51) Int. Cl. G01V 99/00

(52) U.S. Cl. CPC G01V 99/005

(57) ABSTRACT

Systems and methods for geocellular modeling a subset of a geocellular mesh or an array of points that is used to construct a geocellular model of the entire geocellular mesh or array of points.

### CROSS-REFERENCE TO RELATED APPLICATIONS

The priority of U.S. Provisional Patent Application No. 61/909,843 filed Nov. 27, 2013, is hereby claimed and the specification thereof is incorporated herein by reference.

### STATEMENT REGARDING FEDERALLY SPONSORED RESEARCH

Not applicable.

### FIELD OF THE DISCLOSURE

The present disclosure generally relates to systems and methods for geocellular modeling. More particularly, the present disclosure relates to geocellular modeling a subset of a geocellular mesh or an array of points that is used to construct a geocellular model of the entire geocellular mesh or array of points.

### BACKGROUND

High-resolution geological models are traditionally built upon 3D mathematical meshes that provide the numerical architecture for building a structural stratigraphic framework. These models are generally constructed and parameterized through software products that allow professional geoscientists to approximate the static state of a reservoir by interpolating or simulating geologic facies and their petrophysical properties within a reservoir volume. This process is facilitated through the use of a conceptual geological model. The interpolation and simulation algorithms used to fill the inter-well spaces are performed using workflows based on the conceptual models and attempt to bind results to logical rules derived from underlying geologic principles. While the workflows can vary based on individual interpretation of the data, the results are generally obligated to honor the observed data. The interpolation algorithm is responsible for providing the best estimate at every mesh location and the simulation algorithm is responsible for capturing the inherent variability, providing the basis for an uncertainty analysis.

Many aspects of conventional geocellular modeling involve technology that is not well understood such as, for example, mesh design and volume support, stochastic principles including spatial modeling and algorithm selection, appropriate methods for capturing the space of uncertainty and how to integrate the “human” factor in the model. In addition, many conventional geocellular modeling techniques or workflows are based on modeling a reservoir volume when only a portion of the reservoir volume is of interest. Other conventional geocellular modeling techniques or workflows are based on modeling a reservoir volume, in piece-meal fashion, using multiple subsets that collectively cover the entire reservoir volume. In either case, the techniques and workflows are unnecessarily time consuming and often bear less than desirable results. Each of these issues can significantly impact reserve estimation by their effect on dynamic modeling and risk assessment.

### BRIEF DESCRIPTION OF THE DRAWINGS

The present disclosure is described below with references to the accompanying drawings in which like elements are referenced with like reference numerals, and in which:

FIG. 1 is a flow diagram illustrating one embodiment of a method for implementing the present disclosure.

FIG. 2 is a plan view of a geocellular mesh illustrating steps 102, 104 and 106 in FIG. 1.

FIG. 3A is the geocellular mesh in FIG. 2 illustrating step 108 in FIG. 1 with a subset of interpolated or simulated values.

FIG. 3B is the geocellular mesh in FIG. 2 illustrating step 108 in FIG. 1 using a geostatistical simulation technique on a subset.

FIG. 4 is the geocellular mesh in FIG. 3A illustrating step 110 in FIG. 1.

FIG. 5A is the geocellular mesh in FIG. 4 illustrating step 112 in FIG. 1 with a subset of interpolated or simulated values.

FIG. 5B is the geocellular mesh in FIG. 4 illustrating step 112 in FIG. 1 using a geostatistical simulation technique on a subset.

FIG. 6 is a block diagram illustrating one embodiment of a computer system for implementing the present disclosure.

### DETAILED DESCRIPTION OF THE PREFERRED EMBODIMENTS

The present disclosure overcomes one or more deficiencies in the prior art by providing systems and methods for geocellular modeling a subset of a geocellular mesh or an array of points that is used to construct a geocellular model of the entire geocellular mesh or array of points.

In one embodiment, the present disclosure includes a method for geocellular modeling, comprising: i) populating one of each cell and each point without a real property value in each subset selected from a respective one of a geocellular mesh and an array of points with one of an interpolated property value and a simulated property value using all data from one of the geocellular mesh and the array of points; ii) converting one of the interpolated property value and the simulated property value in each one of the cell and the point in each selected subset to a point set using a computer processor; and iii) populating one of each cell and each point without a real property value in the respective one of the geocellular mesh and the array of points only outside each selected subset with one of an interpolated property value and a simulated property value using the data and the point set associated with each respective selected subset.

In another embodiment, the present disclosure includes a non-transitory program carrier device tangibly carrying computer executable instructions for geocellular modeling, the instructions being executable to implement: i) populating one of each cell and each point without a real property value in each subset selected from a respective one of a geocellular mesh and an array of points with one of an interpolated property value and a simulated property value using all data from one of the geocellular mesh and the array of points; ii) converting one of the interpolated property value and the simulated property value in each one of the cell and the point in each selected subset to a point set; and iii) populating one of each cell and each point without a real property value in the respective one of the geocellular mesh and the array of points only outside each selected subset with one of an interpolated property value and a simulated property value using the selected data and the point set associated with each respective selected subset.

In yet another embodiment, the present disclosure includes a non-transitory program carrier device tangibly carrying computer executable instructions for geocellular modeling, the instructions being executable to implement: i) populating each cell without a real property value in each subset selected from a geocellular mesh with one of an interpolated property value and a simulated property value using all data from the geocellular mesh wherein each cell represents a volume with at least three sides; ii) converting one of the interpolated property value and the simulated property value in each cell in each selected subset to a point set; and iii) populating each cell without a real property value in the geocellular mesh only outside each selected subset with one of an interpolated property value and a simulated property value using the data and the point set associated with each respective selected subset.

### Method Description

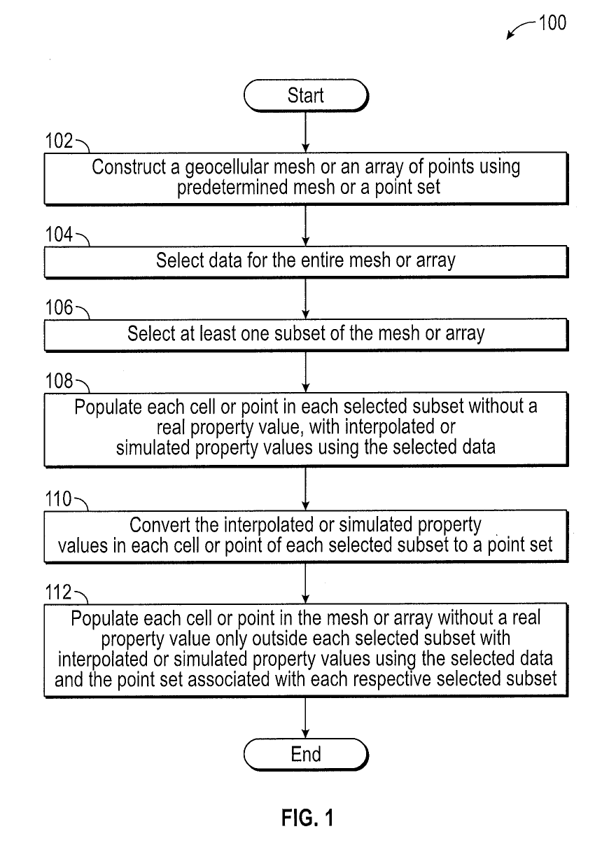

Referring now to FIG. 1, a flow diagram of one embodiment of a method 100 for implementing the present disclosure is illustrated. The method 100 uses a subset of a geocellular mesh (e.g. including structured and unstructured grids) or an array of points (e.g. including regular and irregular spaced points) from a full volume prior to modeling the volume with geological, petrophysical, or mechanical property values, for example. The subset property values are maintained so that they will match exactly the property values in a subsequent full volume geocellular model at the identical location from which the subset was originally selected. The method 100 therefore, is a faster, more efficient method for geocellular modeling than conventional techniques as demonstrated herein.

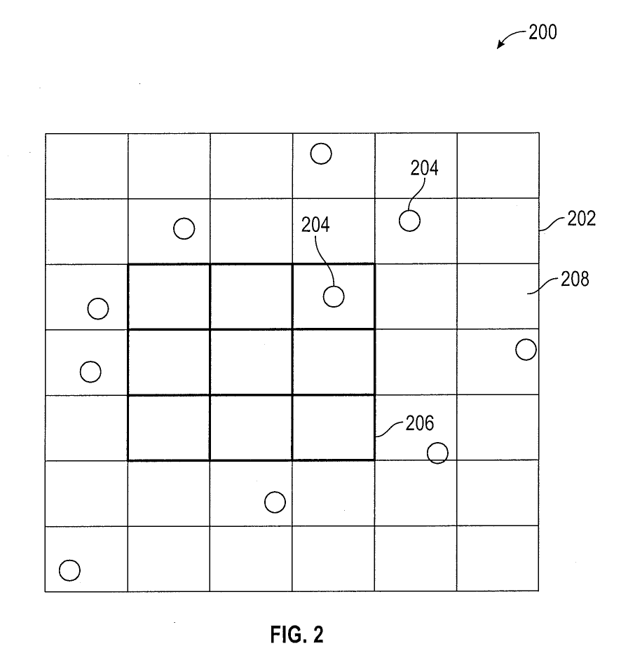

In step 102, a geocellular mesh or an array of points is constructed using predetermined mesh settings or a point set and techniques well known in the art. Predetermined mesh settings include the origin of the mesh such as the x,y,z dimension of the cells in the mesh and the number of cells in each dimension. The point set for the array of points includes x,y,z locations for each point. In FIG. 2, for example, a geocellular mesh 200 is illustrated for a three-dimensional volume of interest 202 in a plan view comprising multiple cells 208. Alternatively, the geocellular mesh 200 may be comprised of any object of at least 3 sides as long as it is closed and encompasses an area or volume.

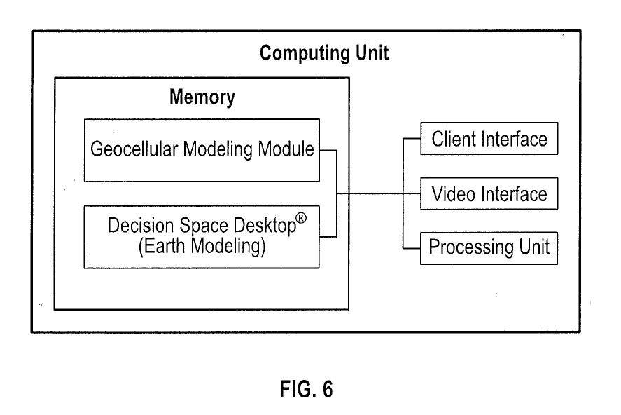

In step 104, data is automatically selected for the entire mesh or array or data may be manually selected using the client interface and/or the video interface described further in reference to FIG. 6, In FIG. 2, for example, the data may include well data from the wells 204 shown as circles in the geocellular mesh 200. The well data generally come from well logs, but may also come from core, seismic, or from any other sources that measure a property at a single or multiple locations in x, or y, or z, or t dimensions. The well data may be recorded at specific locations in the cells 208 of the geocellular mesh 200.

In step 106, at least one subset of the mesh or array is automatically selected or it may be manually selected using the client interface and/or the video interface described further in reference to FIG. 6. In FIG. 2, the subset 206 is selected with one well 204.

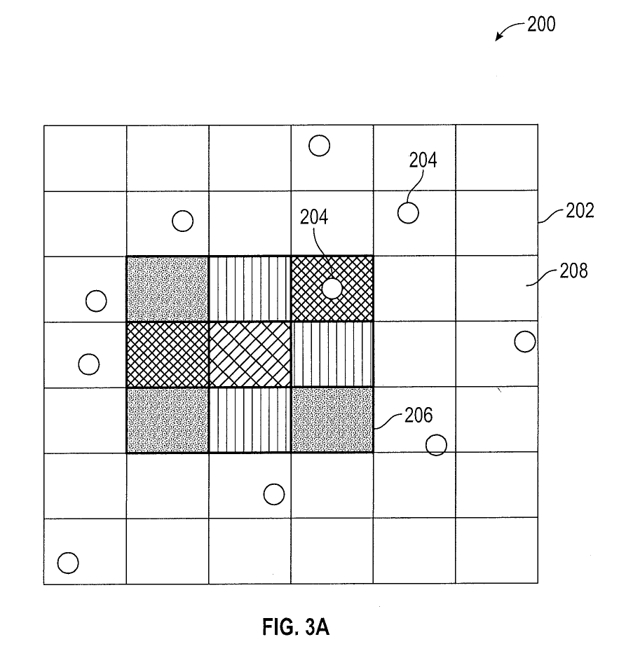

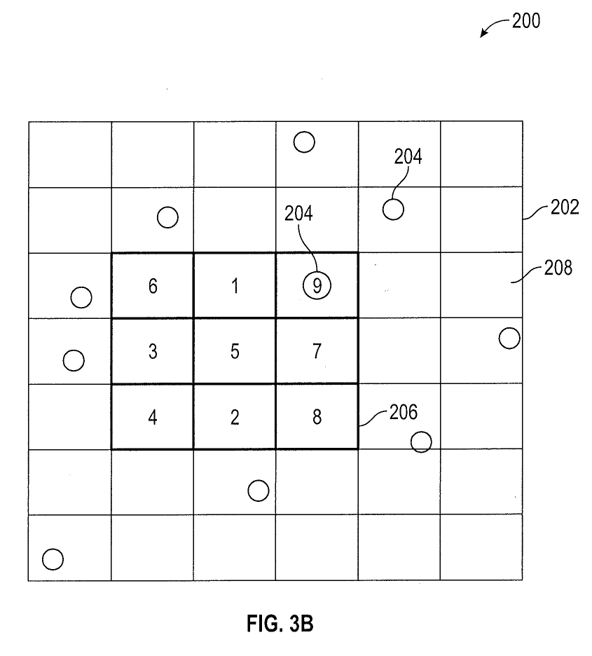

In step 108, each cell or point in each selected subset without a real property value is populated with interpolated or simulated property values using the selected data and techniques well known in the art for interpolation or simulation. If well data exists for a cell, then the well data, or an upscaled version of the well (where cells are coarser than the real well data sampling), is used as the real property value for that cell and possibly other cells if the well from which the well data is taken passes through multiple contiguous cells. In FIG. 3A, the geocellular mesh 200 illustrates the subset 206 populated with different interpolated or simulated property values distinguished from the cells outside subset 206 by the cross-hatching that represents the different property values. The cell with the well 204 in subset 206 honors the well data and thus, uses the real property value for the well data from the well 204 in the cell and is also distinguished from the cells outside subset 206 by its cross-hatching. The remaining cells in subset 206 are populated with interpolated or simulated property values using all of the well data from each well 204 in the geocellular mesh 200 and techniques well known in the art for interpolation or simulation. One technique for simulation may include geostatistical simulation using a Random Walk. In FIG. 3B, for example, the geocellular mesh 200 illustrates populating the subset 206 using a Random Walk. The geostatistical simulation occurs in the subset 206 following the numerical order in each cell established by the Random Walk. The circled number 9 represents a cell with a well 204. This cell thus, uses the real property value for the well data from the well 204.

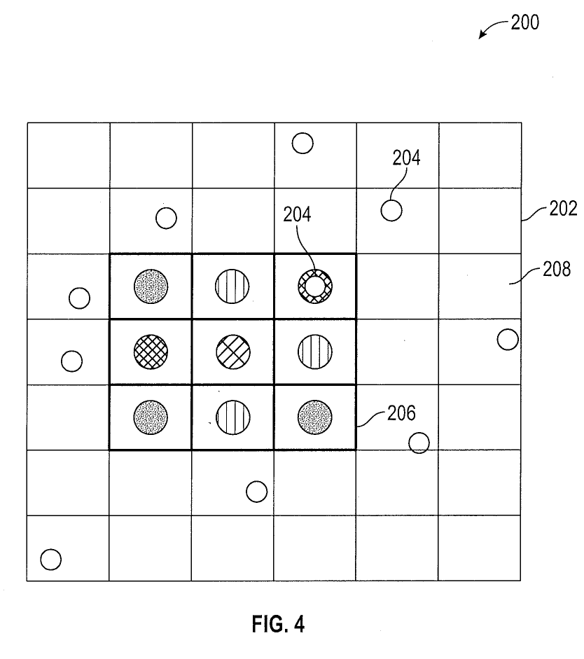

In step 110, the interpolated or simulated property values in each cell or point of each selected subset are converted to a point set using techniques well known in the art. A point set is the set of x, y, and z values that describe the location of stored property values in each respective cell, the respective property value and the location of each respective cell. The interpreted or simulated property values that reside inside a cell are located at a specific point in space defined by an x, y, z location. The specific location could be any point in space (2D or 3D) as long as it is within the geometric boundaries of the cell. Commonly, the center of gravity of the cell is used as the location of the property value. The stored location of the property value would thus, be the center of the cell if the cell is regular in its dimensions. Regardless of the location of the stored property value, the property value is said to be representative of any location within the cell in which it resides. The cell location is generally described as a set on indices composed of the corner points defining its geometry. Commonly, the indices are referred to by i, j, k coordinates. Thus, the interpolated or simulated property values in each cell or point of each selected subset are converted to a point set comprising the x, y, and z location of each stored property value in each respective cell. In FIG. 4, the geocellular mesh 200 illustrates the converted point set in the subset 206, which are used like original well data and include the same cross-hatching as in FIG. 3A that represents the different property values.

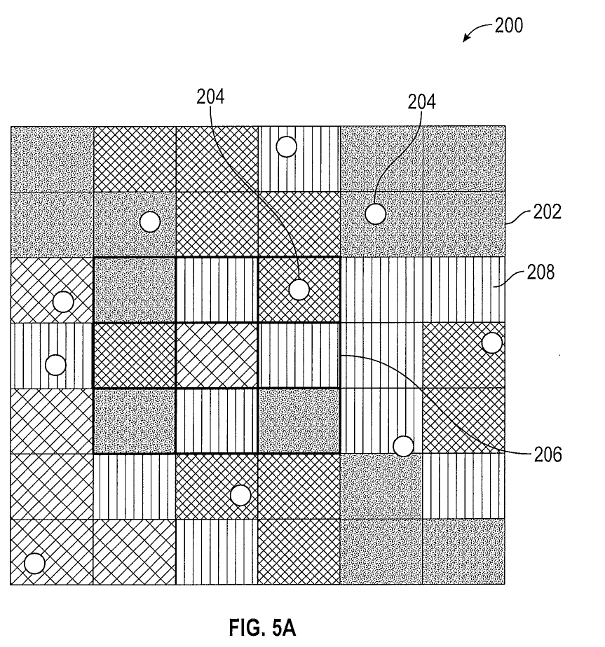

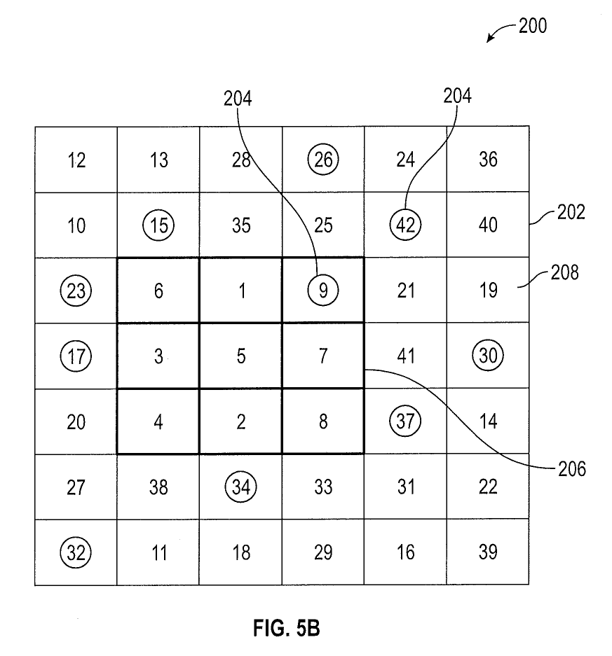

In step 112, each cell or point in the mesh or array without a real property value is populated only outside each selected subset with interpolated or simulated property values using the selected data, the point set associated with each respective selected subset and techniques well known in the art for interpolation or simulation. If well data exists for a cell, then the well data is used as the real property value for that cell and possibly other cells if the well from which the well data is taken passes through multiple contiguous cells. In FIG. 5A, the geocellular mesh 200 illustrates the subset 206 populated with the same interpolated or simulated property values as in FIG. 3A. In addition, each cell with a well 204 honors the well data and thus, uses the real property value for the well data from the well 204 in each respective cell and includes cross-hatching that represent the different property values. The remaining cells in the geocellular mesh 200 outside subset 206 are populated with interpolated or simulated property values using all of the well data from each well 204 in the geocellular mesh 200, the point set in FIG. 4 associated with subset 206 and techniques well known in the art for interpolation or simulation. One technique for simulation may include geostatistical simulation using a Random Walk. In FIG. 5B, for example, the geocellular mesh 200 illustrates populating the geocellular mesh 200 outside subset 206 using a Random Walk. The geostatistical simulation for the subset 206 follows the same numerical order in each cell established by the Random Walk in FIG. 3B and the geostatistical simulation for the rest of the cells in the geocellular mesh 200 outside subset 206 follows the numerical order in each cell established by the Random Walk. The circle numbers represent a cell with a well 204. These cells thus, use the real property value for the well data from the well 204 in each respective cell.

### System Description

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. DecisionSpaceDesktop® Earth Modeling, which is a commercial software application marketed by Landmark Graphics Corporation, may be used as an interface application to implement the present disclosure. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 6, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-5. The memory therefore, includes a geocellular modeling module, which enables step 112 described in reference to FIG. 1. The geocellular modeling module may integrate functionality from the remaining application programs illustrated in FIG. 6. In particular, DecisionSpaceDesktop® Earth Modeling may be used as an interface application to perform the remaining steps in FIG. 1. Although DecisionSpaceDesktop® Earth Modeling may be used as interface application, other interface applications may be used, instead, or the geocellular modeling module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

1. A method for geocellular modeling, which comprises:
populating one of each cell and each point without a real property value in each subset selected from a respective one of a geocellular mesh and an array of points with one of an interpolated property value and a simulated property value using all data from one of the geocellular mesh and the array of points;
converting one of the interpolated property value and the simulated property value in each one of the cell and the point in each selected subset to a point set using a computer processor; and
populating one of each cell and each point without a real property value in the respective one of the geocellular mesh and the array of points only outside each selected subset with one of an interpolated property value and a simulated property value using the data and the point set associated with each respective selected subset.

2. The method of claim 1, wherein the data comprises well data recorded at one of a location in each cell and a location of each point.

3. The method of claim 2, wherein each real property value is represented by a respective well data.

4. The method of claim 1, wherein each simulated property value is simulated by geostatistical simulation using a Random Walk.

5. The method of claim 1, wherein one of the populated geocellular mesh and the populated array of points represents a reservoir volume.

6. The method of claim 1, wherein the geocellular mesh comprises structured and unstructured grids.

7. The method of claim 1, wherein the array of points comprises regular and irregular spaced points.

8. The method of claim 1, wherein each cell represents a volume with at least three sides.

9. A non-transitory program carrier device tangibly carrying computer executable instructions for geocellular modeling, the instructions being executable to implement:
populating one of each cell and each point without a real property value in each subset selected from a respective one of a geocellular mesh and an array of points with one of an interpolated property value and a simulated property value using all data from one of the geocellular mesh and the array of points;
converting one of the interpolated property value and the simulated property value in each one of the cell and the point in each selected subset to a point set; and
populating one of each cell and each point without a real property value in the respective one of the geocellular mesh and the array of points only outside each selected subset with one of an interpolated property value and a simulated property value using the data and the point set associated with each respective selected subset.

10. The program carrier device of claim 9, wherein the data comprises well data recorded at one of a location in each cell and a location of each point.

11. The program carrier device of claim 10, wherein each real property value is represented by a respective well data.

12. The program carrier device of claim 9, wherein each simulated property value is simulated by geostatistical simulation using a Random Walk.

13. The program carrier device of claim 9, wherein one of the populated geocellular mesh and the populated array of points represents a reservoir volume.

14. The program carrier device of claim 9, wherein the geocellular mesh comprises structured and unstructured grids.

15. The program carrier device of claim 9, wherein the array of points comprises regular and irregular spaced points.

16. The program carrier device of claim 9, wherein each cell represents a volume with at least three sides.

17. A non-transitory program carrier device tangibly carrying computer executable instructions for geocellular modeling, the instructions being executable to implement:
populating each cell without a real property value in each subset selected from a geocellular mesh with one of an interpolated property value and a simulated property value using all data from the geocellular mesh wherein each cell represents a volume with at least three sides;
converting one of the interpolated property value and the simulated property value in each cell in each selected subset to a point set; and
populating each cell without a real property value in the geocellular mesh only outside each selected subset with one of an interpolated property value and a simulated property value using the data and the point set associated with each respective selected subset.

18. The program carrier device of claim 17, wherein each simulated property value is simulated by geostatistical simulation using a Random Walk.

19. The program carrier device of claim 17, wherein the geocellular mesh comprises structured and unstructured grids.

20. The program carrier device of claim 17, wherein each real property value is represented by a respective well data.
